(19) United States
(12) Patent Application Publication
(10) Pub. No.: US 2023/0102472 A1
(43) Pub. Date: Mar. 30, 2023

(54) POWER GENERATION SYSTEM FOR AN ARTIFICIAL LIFT SYSTEM

(71) Applicant: Mesquite Technologies LLC, Austin, TX (US)

(72) Inventors: Jose Roberto Navar, Austin, TX (US); Andrew Kenneth Boling, Houston, TX (US)

(21) Appl. No.: 17/957,356

(22) Filed: Sep. 30, 2022

Related U.S. Application Data
(60) Provisional application No. 63/250,613, filed on Sep. 30, 2021.

(51) Int. Cl. H02K 7/18; E21B 43/12; H02K 7/08; H02K 11/00; H02K 11/04

(52) U.S. Cl. CPC H02K 7/1846; E21B 43/127; H02K 7/085; H02K 11/0094; H02K 11/04

(57) ABSTRACT

A power generation system for an artificial lift system includes an electrical generator configured to output electrical power in response to rotation of a rotor of the electrical generator. The power generation system also includes a polish rod engagement wheel non-rotatably coupled to the rotor of the electrical generator. The polish rod engagement wheel is configured to engage a polish rod of the artificial lift system and to be driven to rotate in response to linear movement of the polish rod.

### CROSS-REFERENCE TO RELATED APPLICATION

This application claims priority from and the benefit of U.S. Provisional Application Ser. No. 63/250,613, entitled “POWER GENERATION SYSTEM FOR AN ARTIFICIAL LIFT SYSTEM”, filed Sep. 30, 2021, which is hereby incorporated by reference in its entirety.

### BACKGROUND

The present disclosure relates generally to a power generation system for an artificial lift system.

Wells are drilled into reservoirs to discover and produce oil. The oil within such a reservoir may be under sufficient pressure to drive the oil through the well to the surface. However, over time, the natural pressure of the oil may decline, and an artificial lift system may be used to extract the oil from the reservoir. The artificial lift system may include a pump disposed within the reservoir and a wellhead at the surface. A tubing string may be supported by the wellhead and may extend to the reservoir, and the pump may drive the oil from the reservoir to the wellhead via the tubing string.

The pump is driven by a series of polish rods that extend through the wellhead and the tubing string to the pump. The polish rods are lifted and lowered by a pump jack, which supports the polish rods. The repeated lifting and lowering movement of the polish rods causes the polish rods to wear at the point(s) of contact with the tubing string. Accordingly, certain artificial lift systems include a rod rotator assembly to drive the polish rods to rotate within the tubing string, thereby distributing the wear around the circumference of the polish rods. As a result, the longevity of the polish rods may be increased.

In addition, the wellhead includes a stuffing box configured to establish a seal around a polish rod at the end of the series of polish rods. For example, the stuffing box may include a housing having a passage, and a seal may be disposed within the passage and configured to engage the polish rod. Accordingly, the stuffing box may substantially block flow of oil through the polish rod/stuffing box interface while enabling the upward/downward movement of the polish rods. Certain stuffing boxes include a port extending through the housing and positioned above the seal. Oil that bypasses the seal may flow through the port to an oil sensor configured to detect the quantity and/or rate of oil flow through the seal. If the quantity/rate of oil flow through the seal is greater than a threshold value, a control system may inform an operator and/or terminate operation of the artificial lift system.

Due to the remote location of certain artificial lift systems, it may be difficult to provide electrical power to various components of the artificial lift system, such as the oil sensor. Accordingly, certain artificial lift systems include a solar power system configured to provide electrical power to certain artificial lift system components. Unfortunately, during periods of extended low light conditions (e.g., during extended periods of overcast clouds and/or rain), the power reserve from the solar power system may be insufficient to provide continuous electrical power to the artificial lift system components.

### BRIEF DESCRIPTION

In certain embodiments, a power generation system for an artificial lift system includes an electrical generator configured to output electrical power in response to rotation of a rotor of the electrical generator. The power generation system also includes a polish rod engagement wheel non-rotatably coupled to the rotor of the electrical generator. The polish rod engagement wheel is configured to engage a polish rod of the artificial lift system and to be driven to rotate in response to linear movement of the polish rod.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an artificial lift system having a wellhead;

FIG. 2 is a side view of a portion of the artificial lift system of FIG. 1, including the wellhead and a polish rod connection assembly;

FIG. 3 is a perspective view of an embodiment of a power generation system that may be employed within the wellhead of FIG. 1; and

FIG. 4 is a perspective view of a portion of the power generation system of FIG. 3.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

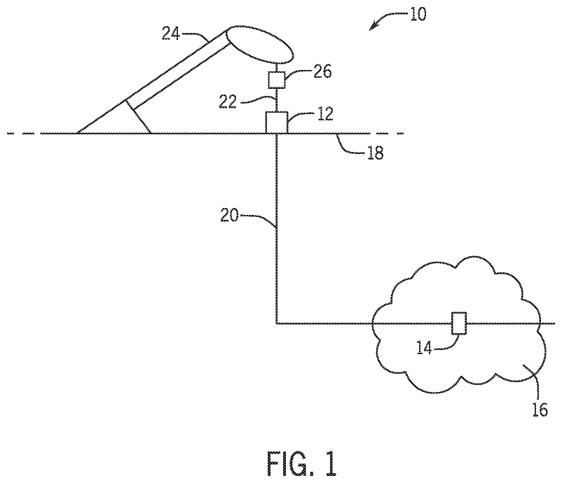

FIG. 1 is a side view of an embodiment of an artificial lift system 10 having a wellhead 12. As illustrated, the artificial lift system 10 includes a pump 14 disposed within a reservoir 16. In addition, the wellhead 12 is positioned at the surface 18. A tubing string 20, which is supported by the wellhead 12, extends from the surface 18 to the reservoir 16. The pump 14 is configured to drive oil from the reservoir 16 to the surface 18 via the tubing string 20 and the wellhead 12.

The pump 14 is driven by a series of polish rods that extend through the tubing string 20 to the pump 14. As illustrated, a polish rod 22 at the end of the series of polish rods is coupled to a pump jack 24 of the artificial lift system 10. The pump jack 24 is configured to lift and lower the polish rods, thereby driving the pump 14. One or more polish rods may contact the tubing string 20 at one or more points along a circumference of the polish rod(s). Accordingly, as the polish rods are driven to move within the tubing string 20, certain point(s) on the polish rod(s) may wear. In the illustrated embodiment, a rod rotator assembly 26 is configured to drive the polish rods to rotate within the tubing string 20, thereby distributing the wear around the circumference of the polish rod(s). As a result, the longevity of the polish rods may be increased. As discussed in detail below, the rod rotator assembly 26 is supported by a carrier (e.g., carrier bar) that is supported by the pump jack 24 via one or more cables. For example, the rod rotator assembly 26 may include a housing supported by the carrier of the artificial lift system 10. In addition, the rod rotator assembly 26 may include a top cap configured to rotate relative to the housing, in which the top cap is configured to support the polish rod 22 (e.g., via polish rod clamp(s)).

Furthermore, as discussed in detail below, the wellhead 12 may include a power generation system configured to generate electrical power from movement of the polish rod 22. In certain embodiments, the power generation system includes an electrical generator configured to output electrical power in response to rotation of a rotor of the electrical generator. In addition, the power generation system includes a polish rod engagement wheel non-rotatably coupled to the rotor. The polish rod engagement wheel is configured to engage the polish rod and to be driven to rotate in response to linear movement of the polish rod. Accordingly, as the polish rod moves upwardly and downwardly during operation of the artificial lift system, the rotor of the electrical generator is driven to rotate. As a result, the electrical generator outputs electrical power to one or more components of the artificial lift system. Because the power generation system generates electrical power while the artificial lift system is in operation, the component(s) of the artificial lift system may receive electrical power throughout the operational duration of the artificial lift system (e.g., as compared to a solar power system having a power reserve insufficient to provide continuous electrical power to the artificial lift system component(s) during extended periods of overcast clouds and/or rain).

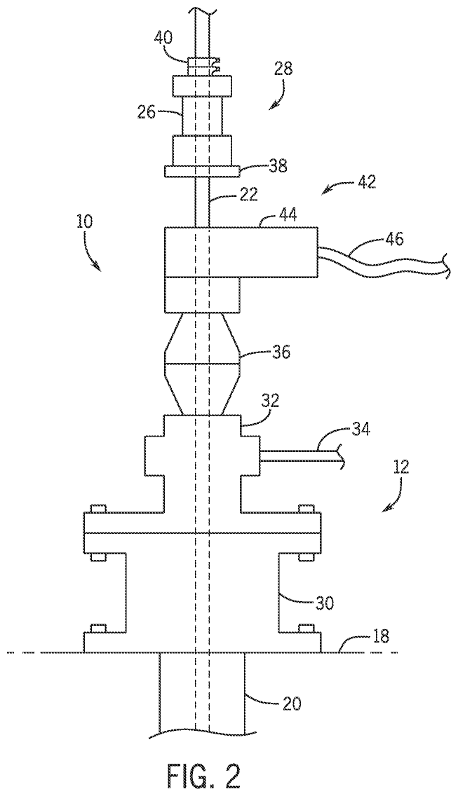

FIG. 2 is a side view of a portion of the artificial lift system 10 of FIG. 1, including the wellhead 12 and a polish rod connection assembly 28. In the illustrated embodiment, the wellhead 12 includes a tubing spool 30 that supports the tubing string 20 (e.g., via a tubing hanger coupled to an end of the tubing string and engaged with the tubing spool). The wellhead 12 also includes a pumping tee 32 coupled to the tubing spool 30 and to a flowline 34. The pumping tee 32 is configured to receive oil from the tubing spool 30 and to control the flow of the oil through the flowline 34. The flowline 34 may extend to a storage or processing facility. Furthermore, the wellhead 12 includes a stuffing box 36 coupled to the pumping tee 32. The stuffing box 36 is configured to establish a seal around the polish rod 22 that substantially blocks flow of oil through the polish rod/stuffing box interface while enabling the upward/downward movement of the polish rods. While the wellhead 12 includes the tubing spool 30, the pumping tee 32, and the stuffing box 36 in the illustrated embodiment, the wellhead may include other and/or additional components in other embodiments.

The polish rod connection assembly 28 includes the rod rotator assembly 26, which is configured to drive the polish rod 22 to rotate relative to the wellhead 12 and the tubing string 20. The polish rod connection assembly 28 also includes a carrier 38 (e.g., carrier bar) configured to support the rod rotator assembly 26. The carrier 38 may be coupled to the pump jack by one or more cables. In addition, the polish rod connection assembly 28 includes one or more polish rod clamps 40 configured to non-movably couple to the polish rod 22. The polish rod clamp(s) 40 transfer the load (e.g., substantially vertical load) of the polish rods to the rod rotator assembly 26, the load flows through the rod rotator assembly 26 to the carrier 38, and the load applied to the carrier is transferred to the pump jack via the cable(s). Accordingly, during an upward movement of the pump jack, the pump jack lifts the carrier 38 via the cable(s), the carrier 38 drives the rod rotator assembly 26 to move upwardly, and the rod rotator assembly 26 drives the polish rods to move upwardly via engagement of the rod rotator assembly 26 with the polish rod clamp(s) 40. During a downward movement of the pump jack, the pump jack drives the polish rod 22 downwardly. Because the polish rod clamp(s) 40 are non-movably coupled to the polish rod 22, the polish rod clamp(s) 40 drive the rod rotator assembly 26 to move downwardly, thereby driving the carrier 38 to move downwardly.

In the illustrated embodiment, the wellhead 12 of the artificial lift system 10 includes a power generation system 42. As discussed in detail below, the power generation system 42 includes a housing 44 and an electrical generator disposed within the housing 44. The electrical generator is configured to output electrical power in response to rotation of a rotor of the electrical generator. In the illustrated embodiment, the electrical generator is electrically coupled to transmission cable(s) 46 of the power generation system 42 and configured to output the electrical power to one or more electrical devices via the transmission cable(s) 46. In addition, the power generation system 42 includes a polish rod engagement wheel non-rotatably coupled to the rotor of the electrical generator. The polish rod engagement wheel is configured to engage the polish rod 22 and to be driven to rotate in response to linear movement of the polish rod 22 (e.g., the upward and downward movement of the polish rod 22). In certain embodiments, the polish rod engagement wheel is also disposed within the housing 44. The power generation system 42 may provide substantially continuous electrical power to various component(s) of the artificial lift system (e.g., as compared to a solar power system having a power reserve insufficient to provide continuous electrical power to the artificial lift system component(s) during extended periods of overcast clouds and/or rain).

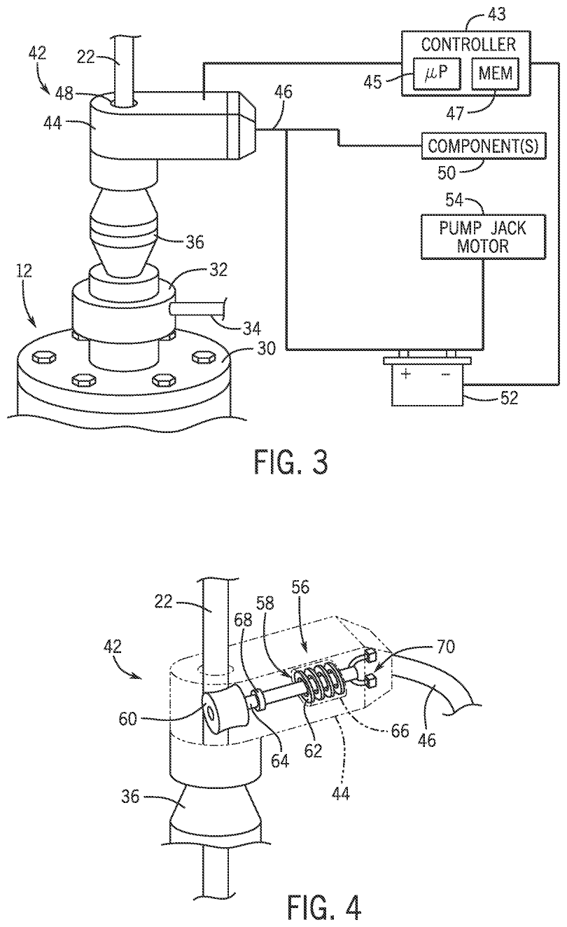

FIG. 3 is a perspective view of an embodiment of a power generation system 42 that may be employed within the wellhead 12 of FIG. 1. As previously discussed, the electrical generator of the power generation system 42 is disposed within the housing 44. In the illustrated embodiment, the housing 44 is positioned above the stuffing box 36 and coupled to the stuffing box 36. However, in other embodiments, the housing may be positioned at any other suitable location and/or coupled to any other suitable structure. For example, in certain embodiments, the housing may be positioned a desired distance above the stuffing box (e.g., separated from the stuffing box by the desired distance), and the housing may be supported by one or more supports (e.g., coupled to any suitable component of the wellhead, coupled to the ground, etc.). Furthermore, in the illustrated embodiment, the housing 44 includes an opening 48 configured to receive the polish rod 22.

As previously discussed, the electrical generator is configured to output electrical power in response to rotation of a rotor of the electrical generator, and a polish rod engagement wheel is non-rotatably coupled to the rotor. The polish rod engagement wheel is configured to engage the polish rod and to be driven to rotate in response to linear movement of the polish rod. Accordingly, the upward and downward movement of the polish rod drives the rotor of the electrical generator to rotate, which causes the electrical generator to generate electrical power. In certain embodiments, the power sufficient to drive the polish rod engagement wheel/rotor to rotate may be significantly less than the power utilized to drive the polish rods to move upwardly and downwardly. In the illustrated embodiment, transmission cable(s) 46 are electrically coupled to the electrical generator and configured to transfer the electrical power from the electrical generator to various component(s) of the artificial lift system.

In the illustrated embodiment, the transmission cable(s) 46 are electrically coupled to one or more components 50 of the artificial lift system, such as one or more components of the wellhead. For example, the components may include one or more sensors (e.g., oil sensor(s), pressure sensor(s), flowrate sensor(s), etc.), one or more actuators (e.g., electromechanical actuator(s), etc.), one or more electronic controllers, one or more transceivers (e.g., wireless transceiver(s), wired transceiver(s), optical transceiver(s), etc.), one or more other suitable electrical devices, or a combination thereof. Because the electrical generator is positioned at the wellhead and configured to provide electrical power to component(s) of the wellhead, a separate electrical power transfer system configured to provide electrical power to the wellhead component(s) from an external electrical source may be obviated, thereby reducing the cost and complexity of the artificial lift system.

In the illustrated embodiment, the transmission cable(s) 46 are also electrically coupled to a power storage system 52 of the power generation system 42. The power storage system may include one or more batteries and/or any other suitable electrical power storage device(s). In certain embodiments, the power storage system 52 may be charged during operation of the artificial lift system (e.g., while the polish rod 22 is moving upwardly and downwardly), and the power storage system 52 may output the electrical power while the artificial lift system is not in operation (e.g., while the polish rod 22 is not moving upwardly and downwardly). The power storage system 52 may output electrical power to the component(s) 50 disclosed above and/or to any other suitable electrical device(s). In certain embodiments, the power storage system 52 is positioned at the wellhead 12. For example, at least a portion of the power storage system may be coupled to and/or disposed within the housing of the power generation system. However, in other embodiments, at least a portion of the power storage system may be positioned remote from the wellhead (e.g., a first portion of the power storage system may be positioned at the wellhead, and a second portion of the power storage system may be positioned remote from the wellhead).

In the illustrated embodiment, the transmission cable(s) 46 are also electrically coupled to an electric pump jack motor 54 (e.g., via the power storage system 52). The electric pump jack motor 54 is configured to drive the pump jack to move the polish rods upwardly and downwardly. In certain embodiments, the electric pump jack motor 54 receives electrical power from an external electrical source (e.g., electrical power grid, local solar power system, local wind power system, local electrical generator, etc.). In the event that the electrical power from the external electrical source is terminated, the power storage system 52 may provide electrical power to the electric pump jack motor 54. In addition, in the event that the electrical power from the external electrical source is reduced below a magnitude sufficient to cause the electric pump jack motor 54 to effectively drive movement of the pump jack, the power storage system 52 may provide supplemental electrical power to the electric pump jack motor in combination with the electrical power provided by the external electrical source. In certain embodiments, the electrical generator may be deactivated/disengaged while the power storage system 52 provides electrical power to the electric pump jack motor 54. However, in other embodiments, the electrical generator may continue operation while the power storage system 52 provides electrical power to the electric pump jack motor 54. In such embodiments, the power storage system 52 and the electrical generator may provide electrical power to the electric pump jack motor in the event that the electrical power from the external electrical source is terminated/reduced.

Furthermore, in certain embodiments, the pump jack may be driven to move the polish rods upwardly and downwardly by the electric pump jack motor 54 and one or more engines (e.g., natural gas fueled engine(s), diesel fueled engine(s), gasoline fueled engine(s), etc.). During normal operation, the engine(s) may drive the pump jack to move. However, in the event that operation of the engine(s) is terminated (e.g., due to interruption in fuel flow, exhaustion of the fuel supply, etc.), the power storage system 52 (e.g., in combination with the electrical generator) may provide electrical power to the electric pump jack motor 54, and the electric pump jack motor 54 may drive the pump jack to move the polish rods upwardly and downwardly. In addition, in the event that the engine(s) provide insufficient power to drive movement of the pump jack, the power storage system 52 may provide electrical power to the electric pump jack motor 54, and the electric pump jack motor 54 may supplement the power provided by the engine(s), thereby effectively driving the pump jack to move the polish rods upwardly and downwardly. In certain embodiments, the electrical generator may be deactivated/disengaged while the power storage system 52 provides electrical power to the electric pump jack motor 54. However, in other embodiments, the electrical generator may continue operation while the power storage system 52 provides electrical power to the electric pump jack motor 54. In such embodiments, the power storage system 52 and the electrical generator may provide electrical power to the electric pump jack motor in the event that operation of the engine(s) is terminated/the engine(s) provide insufficient power. While the electrical generator is electrically coupled to a single electric pump jack motor 54 in the illustrated embodiment, in other embodiments (e.g., in embodiments in which the pump jack is driven by multiple electric pump jack motors), the electrical generator may be electrically coupled to multiple electric pump jack motors (e.g., 2, 3, 4, 5, 6, or more).

In the illustrated embodiment, the power generation system 42 includes a controller 43 configured to control operation and/or electrical power output of the electrical generator. In certain embodiments, the controller 43 is an electronic controller having electrical circuitry configured to control operation and/or electrical power output of the electrical generator. In the illustrated embodiment, the controller 43 includes a processor, such as the illustrated microprocessor 45, and a memory device 47. The controller 43 may also include one or more storage devices and/or other suitable components. The processor 45 may be used to execute software, such as software for controlling operation and/or electrical power output of the electrical generator, and so forth. Moreover, the processor 45 may include multiple microprocessors, one or more “general-purpose” microprocessors, one or more special-purpose microprocessors, and/or one or more application specific integrated circuits (ASICs), or some combination thereof. For example, the processor 45 may include one or more reduced instruction set (RISC) processors.

The memory device 47 may include a volatile memory, such as random access memory (RAM), and/or a nonvolatile memory, such as read-only memory (ROM). The memory device 47 may store a variety of information and may be used for various purposes. For example, the memory device 47 may store processor-executable instructions (e.g., firmware or software) for the processor 45 to execute, such as instructions for controlling operation and/or electrical power output of the electrical generator, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling operation and/or electrical power output of the electrical generator, etc.), and any other suitable data.

In certain embodiments, the controller 43 may be configured to detect termination of operation and/or reduced output of the engine(s), termination and/or reduction of electrical power from the external electrical source, other condition(s) associated with operation of the artificial lift system, or a combination thereof. In addition, the controller 43 may be configured to control flow of electrical power from the power storage system 52 to the electric pump jack motor 54. For example, the controller 43 may initiate electrical power flow from the power storage system 52 to the electric pump jack motor 54 in response to detecting termination of operation of the engine(s), reduced output of the engine(s), termination of electrical power from the external electrical source, a reduction in electrical power from the external electrical source, or a combination thereof. In certain embodiments, the controller 43 may be configured to deactivate/disengage the electrical generator in response to the power storage system 52 providing electrical power to the electric pump jack motor 54. For example, the controller 43 may be configured to terminate electrical power flow from the electrical generator, disengage the polish rod engagement wheel from the polish rod (e.g., instruct an actuator to move the polish rod engagement wheel away from the polish rod, etc.), disengage a clutch between the polish rod engagement wheel and the rotor of the electrical generator, or a combination thereof, in response to the power storage system 52 providing electrical power to the electric pump jack motor 54.

In the illustrated embodiment, the controller 43 is communicatively coupled to the electrical generator (e.g., via electrical circuitry associated with the electrical generator, such as an electrical converter, etc.), and the controller 43 is electrically coupled to the power storage system 52. However, in other embodiments, the controller may be communicatively coupled to other suitable device(s) (e.g., alone or in combination with the electrical generator and/or the power storage system), such as one or more of the component(s) (e.g., sensor(s), actuator(s), transceiver(s), etc.), the electric pump jack motor (e.g., via electrical circuitry associated with the electric pump jack motor), other suitable device(s), or a combination thereof. Furthermore, while the power generation system 42 includes the controller 43 in the illustrated embodiment, in other embodiments, the controller may be omitted.

While the electrical generator is electrically coupled to the component(s) 50, the power storage system 52, and the electric pump jack motor 54 in the illustrated embodiment, in other embodiments, the electrical generator may only be coupled to a subset (e.g., one or two) of the component(s), the power storage system, and the electric pump jack motor. In such embodiments, at least one of the component(s), the power storage system, or the electric pump jack motor may be omitted. For example, in embodiments in which the power storage system is omitted, the electrical generator may be directly electrically coupled to the pump jack motor (e.g., via the transmission cable(s)). Additionally or alternatively, the electrical generator may be electrically coupled to other suitable device(s) configured to receive electrical power. The electrical generator may also be electrically coupled to the electrical power grid, and the electrical generator may output electrical power to the electrical power grid (e.g., to generate revenue from the sale of electrical power to the electric utility). Furthermore, while the electrical generator is electrically coupled to the component(s) 50, the power storage system 52, and the pump jack motor 54 by the transmission cable(s) 46 in the illustrated embodiment, in other embodiments, the electrical generator may be electrically coupled to at least one device via other suitable conductor(s) (e.g., alone or in combination with the transmission cable(s)), such as conductor bar(s), wire(s), other suitable conductor(s), or a combination thereof. In addition, while the power generation system 42 includes a housing 44 in the illustrated embodiment, in other embodiments, the housing may be omitted. In such embodiments, the electrical generator may be coupled to the stuffing box and/or any other suitable support(s).

FIG. 4 is a perspective view of a portion of the power generation system 42 of FIG. 3. As previously discussed, the power generation system 42 includes an electrical generator 56 configured to output electrical power in response to rotation of a rotor 58 of the electrical generator 56. In addition, the power generation system 42 includes a polish rod engagement wheel 60 non-rotatably coupled to the rotor 58 of the electrical generator 56. Accordingly, rotation of the polish rod engagement wheel 60 drives rotation of the rotor 58 of the electrical generator 56. The polish rod engagement wheel 60 is configured to engage the polish rod 22 and to be driven to rotate in response to linear movement of the polish rod 22. Accordingly, the upward and downward movement of the polish rod 22 drives the polish rod engagement wheel 60 to rotate, thereby driving the rotor 58 to rotate. As a result, the electrical generator 56 outputs electrical power.

The polish rod engagement wheel 60 may have any suitable shape for engagement with the polish rod 22. For example, in certain embodiments, the polish rod engagement wheel may have an annular recess, and the radius of curvature of the annular recess may be substantially equal to the radius of the polish rod. In addition, the polish rod engagement wheel 60 may be formed from any suitable material(s) (e.g., brass, polymeric material, etc.). The polish rod engagement wheel 60 may engage the polish rod 22 with a force sufficient to enable the linear movement of the polish rod to drive the polish rod engagement wheel to rotate, while enabling the polish rod to rotate relative to the polish rod engagement wheel, as the polish rod is driven to rotate by the rod rotator assembly. The force may be selected by positioning the electrical generator/housing relative to the polish rod and/or by utilizing a biasing member (e.g., including spring(s), pneumatic cylinder(s), resilient member(s), etc.) configured to urge the polish rod engagement wheel toward the polish rod. Additionally or alternatively, the force may be controlled via an actuator configured to urge the polish rod engagement wheel toward the polish rod. In certain embodiments, the biasing member/actuator may be coupled to the housing and to the stuffing box, and the biasing member/actuator may be configured to drive the housing to translate and/or rotate relative to the stuffing box to urge the polish rod engagement wheel toward the polish rod. In addition, the coefficient of friction of the surface of the polish rod engagement wheel that engages the polish rod may be selected (e.g., via material selection, surface treatment, surface texture, etc.) to enable the linear movement of the polish rod to drive the polish rod engagement wheel to rotate, while enabling the polish rod to rotate relative to the polish rod engagement wheel, as the polish rod is driven to rotate by the rod rotator assembly. For example, in certain embodiments, the surface of the polish rod engagement wheel that engages the polish rod may be formed from a different material (e.g., rubber, polymeric material, etc.) than a body of the polish rod engagement wheel (e.g., brass, steel, etc.).

In the illustrated embodiment, the rotor 58 includes coil(s) of electrically conductive wire 62, and the rotor 58 is non-rotatably coupled to an input shaft 64 of the electrical generator 56. The coil(s) of electrically conductive wire 62 are wrapped around and non-rotatably coupled to the input shaft 64. In addition, the input shaft 64 is non-rotatably coupled to the polish rod engagement wheel 60. Accordingly, in the illustrated embodiment, the polish rod engagement wheel 60 is non-rotatably coupled to the rotor 58 via the input shaft 64. However, in other embodiments, the input shaft may be omitted, and the polish rod engagement wheel may be non-rotatably coupled to the rotor.

Furthermore, in certain embodiments, a clutch may be positioned between the polish rod engagement wheel and the rotor (e.g., along the input shaft). In such embodiments, the clutch is configured to selectively non-rotatably couple the polish rod engagement wheel and the rotor. For example, to deactivate/disengage the electrical generator, the clutch may be disengaged (e.g., via the controller), and to activate/engage the electrical generator, the clutch may be engaged (e.g., via the controller). In addition, in certain embodiments, the power generation system may include an actuator configured to drive the polish rod engagement wheel to disengage the polish rod to deactivate/disengage the electrical generator. For example, the actuator may be controlled (e.g., via the controller) to drive the input shaft to pivot and/or translate, such that the polish rod engagement wheel moves away from the polish rod, thereby deactivating/disengaging the electrical generator. The actuator may also be controlled (e.g., via the controller) to drive the input shaft to pivot and/or translate, such that the polish rod engagement wheel moves toward the polish rod, thereby activating/engaging the electrical generator. Furthermore, in certain embodiments, the actuator may be controlled (e.g., via the controller) to adjust the contact force between the polish rod engagement wheel and the polish rod. The actuator may be coupled to any suitable component(s) of the power generation system. For example, the actuator may be coupled to the housing and to the stuffing box, and the actuator may be configured to drive the housing to translate and/or rotate relative to the stuffing box to control the engagement/contact force between the polish rod engagement wheel and the polish rod.

In addition, the electrical generator 56 includes a stator 66 having permanent magnet(s) or coil(s) of electrically conductive wire. In the illustrated embodiment, the stator 66 is non-rotatably (e.g., fixedly) coupled to the housing 44. For example, the stator may be non-rotatably (e.g., fixedly) coupled to an enclosure of the electrical generator, and the enclosure of the electrical generator may be non-rotatably (e.g., fixedly) coupled to the housing. In embodiments in which the housing of the power generation system is omitted, the stator may be non-rotatably (e.g., fixedly) coupled to the stuffing box and/or any other suitable support(s). For example, the stator may be non-rotatably (e.g., fixedly) coupled to an enclosure of the electrical generator, and the enclosure of the electrical generator may be non-rotatably (e.g., fixedly) coupled to the stuffing box/other suitable support(s). Rotation of the rotor 58 relative to the stator 66 generates electrical power, which is output by the electrical generator 56. While the rotor includes coil(s) of electrically conductive wire in the illustrated embodiment, in other embodiments, the rotor may include one or more permanent magnets. In such embodiments, the stator may include coil(s) of electrically conductive wire.

In the illustrated embodiment, the power generation system 42 includes a bearing 68 disposed about the input shaft 64 and coupled to the housing 44. The bearing 68 is configured to facilitate rotation of the input shaft 64 relative to the housing 44 and to reduce deflection and/or bending of the input shaft due to contact between the polish rod engagement wheel 60 and the polish rod 22. The bearing 68 may include any suitable type(s) of bearing(s), such as ball bearing(s), cylindrical roller bearing(s), bushing(s), other suitable type(s) of bearing(s), or a combination thereof. Furthermore, in certain embodiments, the power generation system may include multiple bearings disposed along the length of the input shaft. In addition, in certain embodiments (e.g., in embodiments without an input shaft, etc.), the bearing may be omitted.

In the illustrated embodiment, the power generation system 42 includes an electrical converter 70 configured to receive the electrical power from the electrical generator 56 and to convert the electrical power into direct current electrical power. In the illustrated embodiment, the electrical converter 70 is disposed within the housing 44. However, in other embodiments, the electrical converter may be disposed at another suitable location. In certain embodiments, the electrical generator 56 is configured to output alternating current electrical power. In such embodiments, the electrical converter 70 may receive the alternating current electrical power from the electrical generator 56 and output direct current electrical power (e.g., via the transmission cable(s)). The direct current electrical power may be supplied to the component(s) of the artificial lift system (e.g., component(s) of the wellhead), the power storage system, the electric pump jack motor, other suitable device(s), or a combination thereof. In certain embodiments, the electrical generator may be configured to output direct current electrical power. In such embodiments, the electrical converter may be omitted. Furthermore, in certain embodiments, the component(s) of the artificial lift system and/or the electric pump jack motor may be electrically coupled to the electrical generator via the power storage system. Accordingly, variations in the electrical power output by the electrical generator (e.g., due to transitions between the upward and downward movement of the polish rod, etc.) may be substantially damped by the power storage system, such that the component(s)/electric pump jack motor receive substantially consistent electrical power. In addition, in certain embodiments, the electrical generator may be configured to output alternating current electrical power, and the electrical converter may be omitted. In such embodiments, the component(s) and/or the electric pump jack motor may receive alternating current electrical power.

While the power generation system 42 includes a single electrical generator 56 in the illustrated embodiment, in other embodiments, the power generation system may include multiple electrical generators (e.g., within a common housing, within separate housings, or a combination thereof). In such embodiments, respective polish rod engagement wheels may be non-rotatably coupled to the rotors of the electrical generators, and each respective polish rod engagement wheel may be configured to engage the polish rod and to be driven to rotate in response to linear movement of the polish rod. For example, in certain embodiments, the power generation system may include a first electrical generator configured to output electrical power while the polish rod moves downwardly and a second electrical generator configured to output electrical power while the polish rod moves upwardly. Furthermore, in certain embodiments, the power generation system may include an additional/alternative electrical generator having a rotor non-rotatably coupled to a rotating component of the pump jack (e.g., alone or in combination with the electrical generator disclosed above having a rotor non-rotatably coupled to a polish rod engagement wheel). In such embodiments, with regard to the additional/alternative generator, the power generation system may include any of the features and variations disclosed above (e.g., with regard to the generator rotor/stator, with regard to the electrical converter, with regard to the electrical connection(s) to the component(s)/power storage system/pump jack motor, with regard to the controller, etc.).

Furthermore, in certain embodiments, the power generation system may include one or more thermoelectric generators (e.g., alone or in combination with the electrical generator having a rotor non-rotatably coupled to a polish rod engagement wheel). The thermoelectric generator(s) are configured to convert heat from the wellhead into electrical power. For example, at least one thermoelectric generator may be coupled to the stuffing box (e.g., between the stuffing box and the power generation system housing, etc.) and configured to convert heat from the stuffing box into electrical power. The heat from the stuffing box may be generated due to friction between the polish rod and the seal(s) within the stuffing box and/or due to the elevated temperature of the oil extracted from the reservoir. In certain embodiments, the thermoelectric generator(s) may be electrically coupled to the component(s), the power storage system, the electric pump jack motor, or a combination thereof. Furthermore, the thermoelectric generator(s) may be communicatively and/or electrically coupled to the controller disclosed above.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A power generation system for an artificial lift system, comprising:
an electrical generator configured to output electrical power in response to rotation of a rotor of the electrical generator; and
a polish rod engagement wheel non-rotatably coupled to the rotor of the electrical generator, wherein the polish rod engagement wheel is configured to engage a polish rod of the artificial lift system and to be driven to rotate in response to linear movement of the polish rod.

2. The power generation system of claim 1, comprising a housing, wherein the electrical generator and the polish rod engagement wheel are disposed within the housing.

3. The power generation system of claim 2, wherein the electrical generator comprises an input shaft non-rotatably coupled to the rotor and to the polish rod engagement wheel.

4. The power generation system of claim 3, comprising a bearing disposed about the input shaft of the electrical generator and engaged with the housing.

5. The power generation system of claim 1, comprising an electrical converter configured to receive the electrical power from the electrical generator and to convert the electrical power into direct current electrical power.

6. The power generation system of claim 1, comprising a power storage system electrically coupled to the electrical generator and configured to store the electrical power from the electrical generator.

7. The power generation system of claim 1, comprising a controller communicatively coupled to the electrical generator, wherein the controller comprises a processor and a memory, and the controller is configured to control operation of the electrical generator, control output of the electrical power from the electrical generator, or a combination thereof.

8. A power generation system for an artificial lift system, comprising:
a housing;
an electrical generator disposed within the housing, wherein the electrical generator comprises a rotor and a stator, the stator is non-rotatably coupled to the housing, and the electrical generator is configured to output electrical power in response to rotation of the rotor relative to the stator; and
a polish rod engagement wheel non-rotatably coupled to the rotor, wherein the polish rod engagement wheel is configured to engage a polish rod of the artificial lift system and to be driven to rotate in response to linear movement of the polish rod.

9. The power generation system of claim 8, wherein the rotor comprises a coil of electrically conductive wire.

10. The power generation system of claim 8, wherein the electrical generator comprises an input shaft non-rotatably coupled to the rotor and to the polish rod engagement wheel.

11. The power generation system of claim 10, comprising a bearing disposed about the input shaft of the electrical generator and engaged with the housing.

12. The power generation system of claim 8, comprising an electrical converter disposed within the housing, wherein the electrical converter is configured to receive the electrical power from the electrical generator and to convert the electrical power into direct current electrical power.

13. The power generation system of claim 8, comprising a power storage system electrically coupled to the electrical generator and configured to store the electrical power from the electrical generator.

14. The power generation system of claim 8, comprising a controller communicatively coupled to the electrical generator, wherein the controller comprises a processor and a memory, and the controller is configured to control operation of the electrical generator, control output of the electrical power from the electrical generator, or a combination thereof.

15. An artificial lift system, comprising:
a polish rod configured to be driven in linear movement by a pump jack; and
a power generation system, comprising:
an electrical generator configured to output electrical power in response to rotation of a rotor of the electrical generator; and
a polish rod engagement wheel non-rotatably coupled to the rotor of the electrical generator, wherein the polish rod engagement wheel is engaged with the polish rod of the artificial lift system and configured to be driven to rotate in response to the linear movement of the polish rod.

16. The artificial lift system of claim 15, wherein the power generation system comprises a housing, and the electrical generator and the polish rod engagement wheel are disposed within the housing.

17. The artificial lift system of claim 16, wherein the electrical generator comprises an input shaft non-rotatably coupled to the rotor and to the polish rod engagement wheel.

18. The artificial lift system of claim 17, wherein the power generation system comprises a bearing disposed about the input shaft of the electrical generator and engaged with the housing.

19. The artificial lift system of claim 15, wherein the power generation system comprises a power storage system electrically coupled to the electrical generator and configured to store the electrical power from the electrical generator.

20. The artificial lift system of claim 15, comprising an electric pump jack motor configured to drive the pump jack to move the polish rod, wherein the electric pump jack motor is configured to receive the electrical power from the electrical generator.
